(19) United States
(12) Patent Application Publication
(10) Pub. No.: US 2011/0045876 A1
(43) Pub. Date: Feb. 24, 2011

(54) MOBILE COMMUNICATION DEVICE HAVING ROTATABLE CASE

(75) Inventor: CHUN-CHENG KO, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/775,433

(22) Filed: May 6, 2010

(30) Foreign Application Priority Data
Aug. 18, 2009 (CN) 200910305741.X

(51) Int. Cl. H04W 88/02

(52) U.S. Cl. 455/575.1

(57) ABSTRACT

A mobile communication device includes a main body and a case. The case is rotatably received in the main body. The case is adapted to receive a battery and a subscriber identity module card. The battery is adapted to supply power to the mobile communication device. The subscriber identity module card is operable to store a service-subscriber key for identifying a subscriber of the mobile communication device. The case is operable to rotate relative to the main body, so as to expose the battery and the subscriber identity module card out of the main body.

### BACKGROUND

1. Technical Field

The present disclosure relates to communication devices, and particularly to a mobile communication device.

2. Description of Related Art

A typical mobile phone usually has a battery and a subscriber identity module (SIM) card. To remove the battery or the SIM card of the mobile phone, a user needs to first detach a rear cover of the mobile phone, this can be very inconvenient.

Therefore, it is desirable to provide a mobile communication device having a rotatable case for receiving a battery and/or a SIM card, which can overcome the above-mentioned problems.

### BRIEF DESCRIPTION OF THE FIGURE

The components of the drawings are not necessarily drawn to scale, the emphasis instead being placed upon clearly illustrating the principles of the embodiment of a mobile communication device. Moreover, in the drawings, like reference numerals designate corresponding parts throughout several views.

FIG. 1 is an assembled, isometric, schematic view of a mobile communication device having a rotatable case, according to an exemplary embodiment.

FIG. 2 is an exploded view of the device of FIG. 1.

FIG. 3 is a schematic view of the case of the mobile communication device of FIG. 1 from another view angle.

FIG. 4 is a sectional view of the mobile communication device of FIG. 1.

FIG. 5 is an assembled view of the mobile communication device of FIG. 1 in another state.

### DETAILED DESCRIPTION

Embodiments of the present disclosure will now be described in detail with reference to the drawings.

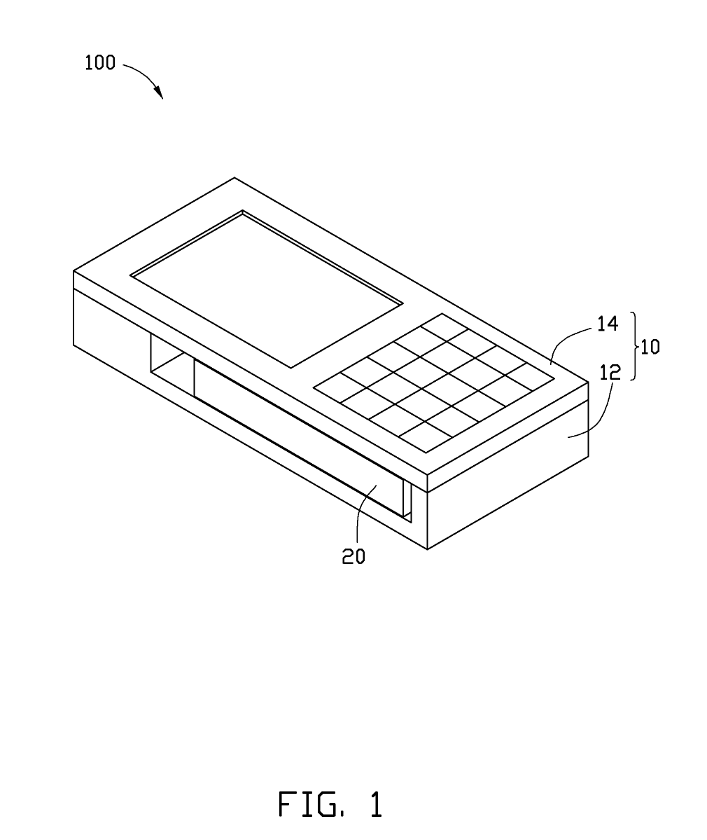

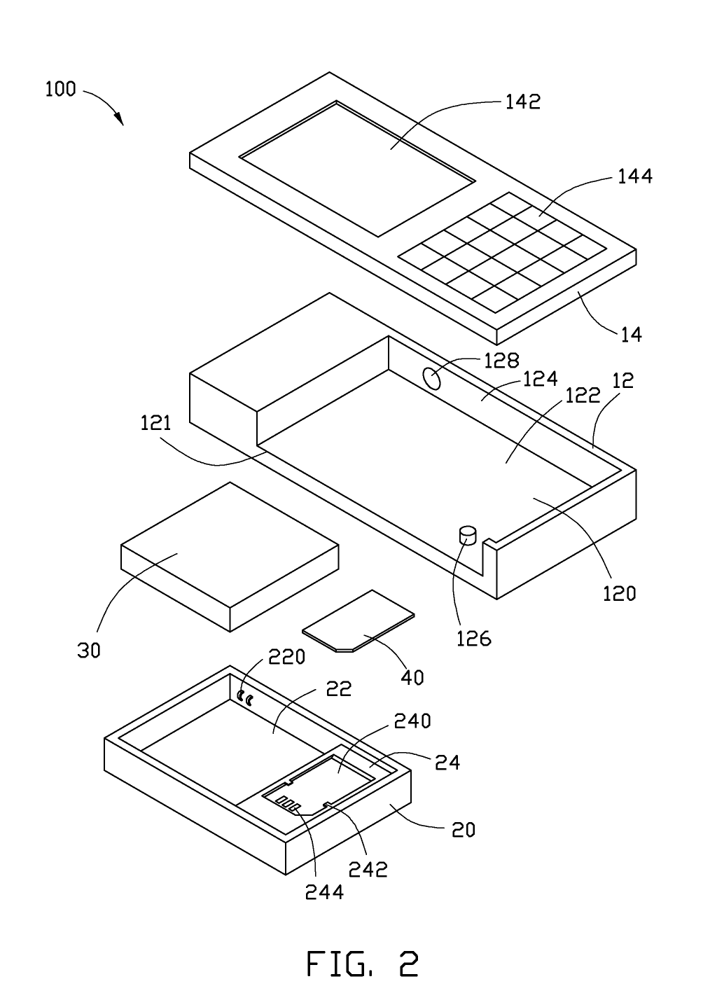

Referring to FIGS. 1 and 2, a mobile communication device 100 includes a main body 10, a case 20, a battery 30, and a SIM card 40. The case 20 is rotatably received in the main body 10, and is adapted to receive the battery 30 and the SIM card 40. The battery 30 is adapted to supply power to the mobile communication device 100. The SIM card 40 stores a service-subscriber key used to identify a subscriber of the mobile communication device 100. In this embodiment, the mobile communication device 100 may be a mobile phone.

The main body 10 includes a bottom portion 12 and a top portion 14. The bottom portion 12 defines a rectangular space 120, and forms a surface 122 and three sidewalls on three sides of the space 120 and an opening 121 in a side of the space 120 facing a sidewall 124. The bottom portion 12 includes a shaft 126 and a first magnet 128. The shaft 126 extends upright from the surface 122. The first magnet 128 is embedded in the sidewall 124. The bottom portion 12 further includes a number of circuitries (not shown), which are adapted to implement desirable functions. The top portion 14, includes a display 142 and a keypad 144, covers on the bottom portion 12.

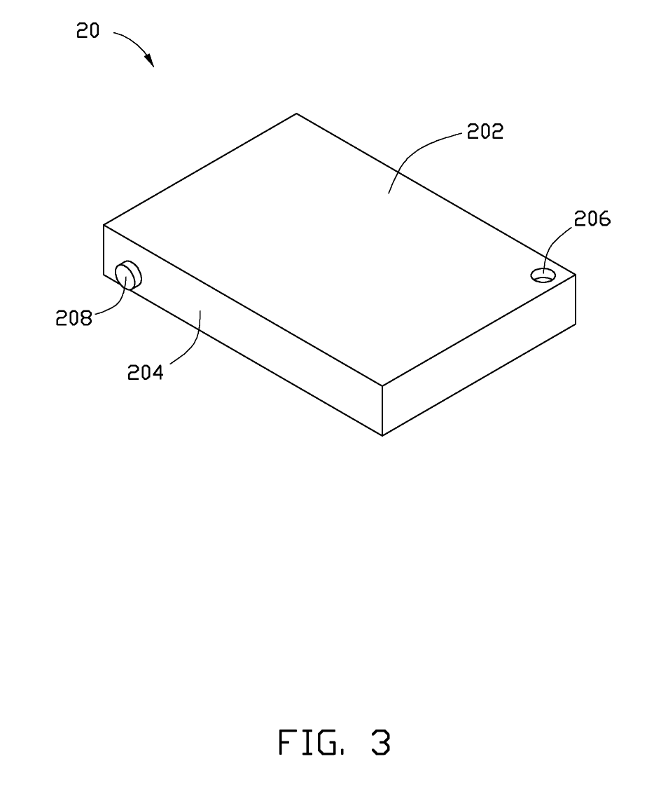

The case 20 is rectangular in shape. The size of the case 20 is smaller than that of the space 120, such that the case 20 can be rotatably received in the space 120. Further referring to FIG. 3, the case 20 includes a bottom surface 202 and a side surface 204 substantially perpendicular to the bottom surface 202. The case 20 defines a pivot hole 206 in the bottom surface 202 for allowing the shaft 126 to be inserted therein. The case 20 includes a second magnet 208 disposed on the side surface 204 and protruding out of the side surface 204. The second magnet 208 is adapted to attract the first magnet 128.

The case 20 further defines a first receiving space 22 for receiving the battery 30 and forms a platform 24 adjacent to the first receiving space 22. The case 20 further includes connecting members 220 formed on a sidewall (not labeled) of the case 20. The connecting members 220 are electrically connected to the circuitries of the bottom portion 12 via wires (not shown), so as to electrically connect the battery 30 with the circuitries of the bottom portion 12. The connecting members 220 are elastically deformable, such that the connecting members 220 are operable to resist the battery 30. The case 20 further defines a second receiving space 240 in the platform 24 for receiving the SIM card 40. The case 20 includes a number of connecting fingers 244 and two positioning members 242. The connecting fingers 244 are disposed on a bottom of the second receiving space 240 and electrically connected to the circuitries of the bottom portion 12. The two positioning members 242 project into the second receiving space 22.

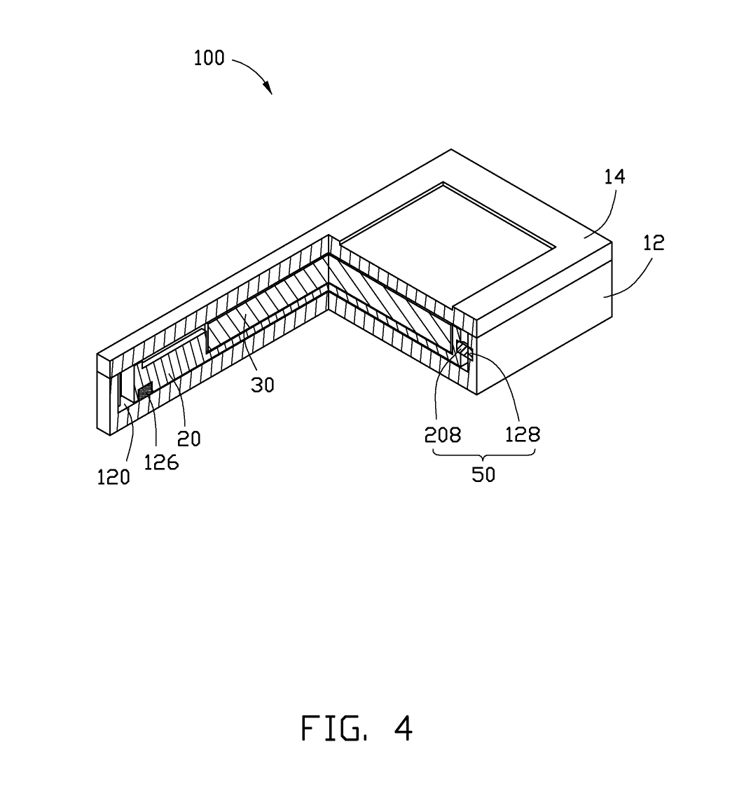

Further referring to FIG. 4, to assembly the mobile communication device 100, the case 20 is rotatably received in the space 120 by inserting the shaft 126 into the pivot hole 206, and then the top portion 14 is placed on the bottom portion 12. The case 20 is spaced a predetermined distance away from the sidewall 124, such that the case 20 is operable to rotate in the space 120. The battery 30 is received in the first receiving space 22 and is resisted by the connecting members 220. The battery 30 is electrically connected to the circuitries of the bottom portion 12 via the connecting members 220. The SIM card 40 is inserted into the second receiving space 240 and is restricted by the positioning members 242. The SIM card 40 is electrically connected to the connecting fingers 244. The case 20 is rotated to be wholly received in the space 120. The second magnet 208 faces and attracts the first magnet 128, such that the case 20 is fixed. In other words, the first magnet 128 and the second magnet 208 constitute a fixing mechanism 50 for fixing the case 20 in the space 120.

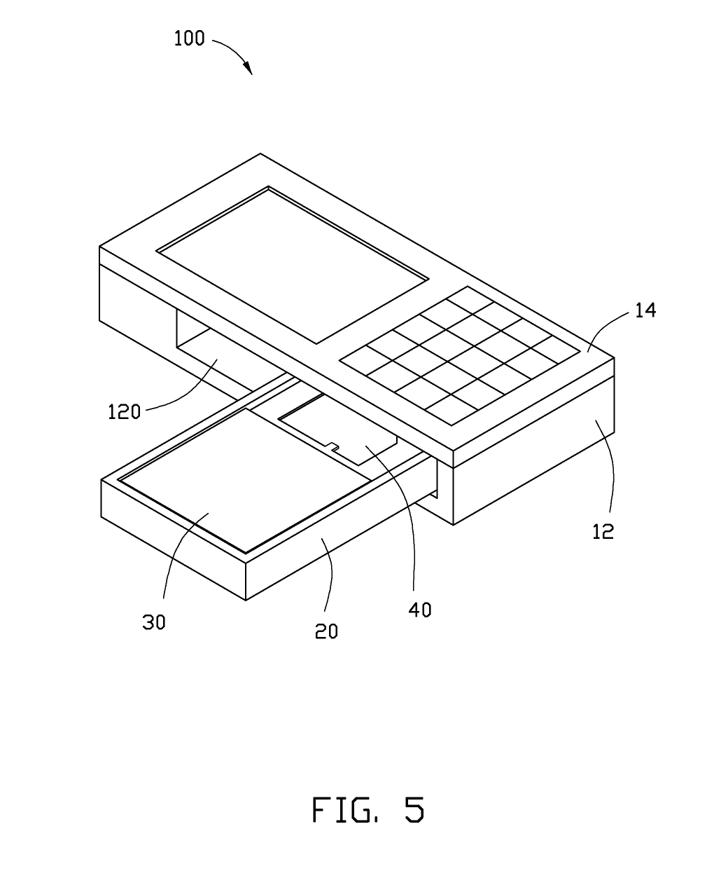

Referring to FIG. 5, to remove the battery 30 and the SIM card 40, the case 20 is rotated to expose the battery 30 and the SIM card 40 from the space 120 by applying a force to the case 20. Accordingly, the battery 30 and the SIM card 40 can be removed conveniently.

It is noteworthy to mention that, the first magnet 128 and the second magnet 208 can be substituted by other fixing methods, for example, a fixing hole and an elastic member operable to be inserted into the fixing hole.

It is also noteworthy to mention that, the case 20 is not limited to receive both of the battery 30 and the SIM card 40. Alternatively, the case 20 may be used to receive just the battery 30 or just the SIM card 40.

While various exemplary and preferred embodiments have been described, it is to be understood that the disclosure is not limited thereto. To the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A mobile communication device, comprising:
a main body; and
a case rotatably received in the main body, the case being adapted to receive at least one of a battery and a subscriber identity module card, the battery being adapted to supply power to the mobile communication device, the subscriber identity module card being operable to store a service-subscriber key for identifying a subscriber of the mobile communication device, the case being operable to rotate relative to the main body, so as to expose the at least one of the battery and the subscriber identity module card out of the main body.

2. The mobile communication device of claim 1, wherein the main body defines a space and comprises a shaft received in the space, the case defines a pivot hole therein, the shaft is inserted into the pivot hole, such that the case is received in the space and is rotatable relative to the main body.

3. The mobile communication device of claim 1, further comprising a fixing mechanism, the fixing mechanism being operable to retain the case when the case is wholly received in the main body.

4. The mobile communication device of claim 3, wherein the fixing mechanism comprises a first magnet and a second magnet, the first magnet is disposed in the main body, the second magnet is disposed in the case, the second magnet is operable to attract the first magnet when the case is wholly received in the main body, so as to retain the case.

5. The mobile communication device of claim 1, wherein the case defines a first receiving space and a second receiving space adjacent to the first receiving space, the first receiving space and the second receiving space are adapted to receive the battery and the subscriber identity module card respectively.

6. The mobile communication device of claim 5, further comprising connecting members and a plurality of connecting fingers, the connecting members being disposed adjacent to the first receiving space and operable to electrically connect the battery to the main body, the plurality of connecting fingers being disposed in the second receiving space and operable to electrically connect the subscriber identity module card to the main body.

7. The mobile communication device of claim 5, further comprising at least one positioning member, the positioning member being suspended over the second receiving space to restrict the subscriber identity module card.

8. A mobile communication device, comprising:
a main body; and
a case rotatably received in the main body, the case being adapted to receive at least one of a battery and a subscriber identity module card, the case being wholly received in the main body in a first state, and being rotated to be partially received in the main body in a second state to expose the at least one of the battery and the subscriber identity module card out of the main body.

9. The mobile communication device of claim 8, wherein the main body defines a space and comprises a shaft received in the space, the case defines a pivot hole therein, the shaft is inserted into the pivot hole, such that the case is received in the space and is rotatable relative to the main body.

10. The mobile communication device of claim 8, further comprising a fixing mechanism, the fixing mechanism being operable to retain the case when the case is wholly received in the main body.

11. The mobile communication device of claim 11, wherein the fixing mechanism comprises a first magnet and a second magnet, the first magnet is disposed in the main body, the second magnet is disposed in the case, the second magnet is operable to attract the first magnet when the case is wholly received in the main body, so as to retain the case.

12. The mobile communication device of claim 8, wherein the case defines a first receiving space and a second receiving space adjacent to the first receiving space, the first receiving space and the second receiving space are respectively adapted to receive the battery and the subscriber identity module card.

13. The mobile communication device of claim 12, further comprising connecting members and a plurality of connecting fingers, the connecting members being disposed adjacent to the first receiving space and operable to electrically connect the battery to the main body, the plurality of connecting fingers being disposed in the second receiving space and operable to electrically connect the subscriber identity module card to the main body.

14. The mobile communication device of claim 12, further comprising at least one positioning member, the positioning member being suspended over the second receiving space to restrict the subscriber identity module card.
